(19) United States
(12) Patent Application Publication
(10) Pub. No.: US 2007/0023678 A1
(43) Pub. Date: Feb. 1, 2007

(54) Method and apparatus for ionization by cluster-ion impact

(75) Inventor: Kenzo Hiraoka, Yamanashi (JP)

Correspondence Address: DICKSTEIN SHAPIRO LLP, 1825 EYE STREET NW, Washington, DC, 20006-5403, US

(73) Assignee: Yamanashi TLO Co., Ltd.

(21) Appl. No.: 11/514,132

(22) Filed: Sep. 1, 2006

Related U.S. Application Data
(63) Continuation-in-part of application No. 10/567,382, filed on Feb. 7, 2006.

(51) Int. Cl. H01J 27/00

(52) U.S. Cl. 250/425

(57) ABSTRACT

Biological molecules such as protein molecules are ionized without being damaged. Massive cluster ions of a water/methanol mixture (to which acetic acid or ammonia, etc., has been added) (in the vicinity of dry ice—acetone temperature) are generated in a charged-droplet generating chamber by a cold electrospray, and the ions are accelerated in an evacuated acceleration chamber by a high-voltage electric field on the order of 10 KV, thereby bombarding a biological sample thin film, which has been applied to a cooled specimen substrate, and achieving ionization of large biomolecules.

### CROSS-REFERENCE TO RELATED APPLICATIONS

This application is a continuation-in-part of U.S. patent application Ser. No. 10/567,382, filed on Feb. 27, 2004; and claims priority to PCT Application No. PCT/JP2004/002344, filed on Feb. 27, 2004, and amended on Sep. 6, 2005; each of which are incorporated herein by reference.

### BACKGROUND OF THE INVENTION

1. Field of the Invention

This invention relates to a method and apparatus for ionization by cluster-ion impact. More particularly, the invention relates to an ionization method and apparatus ideal for mass analysis (mass spectrometry) of large biomolecules such as protein molecules and DNA molecules.

2. Description of the Related Art

An ionized gas must be supplied to a mass analyzer (mass spectrograph or spectrometer) in order to perform mass analysis. Because ionized molecules or atoms recombine with ions or electrons of the opposite polarity in a very short time, it is necessary to suppress this.

The ion impact method is one method of performing ionization for the mass analysis of a biological sample that has been mixed in a matrix. With a secondary-ion mass analysis method using Ar+ or Xe+ as the primary ion, the matrix molecules sustain severe damage. Hence the method is not suitable for analyzing large biomolecules. In addition, chemical noise appears and the S/N ratio is poor.

A Massive Cluster Impact method (referred to as the “MCI method” below) has been developed as a new ionization method that eliminates these drawbacks. [See J. F. Mahoney, D. S. Cornett and T. D. Lee, “Formation of Multiply Charged Ions from Large Molecules Using Massive-cluster Impact”, RAPID COMMUNICATIONS IN MASS SPECTROMETRY, VOL. 8, 403-406 (1994).] This method involves electrostatic spraying of glycerol and bombards a matrix sample with ion clusters having masses of 10⁶ to 10⁷ u charged to a valency of +100 to +1000. In accordance with this method, large biomolecules are not decomposed and a mass spectra with little chemical noise are obtained.

Since the above method uses glycerol, however, a problem which arises is that the ion source becomes contaminated and charged, rendering the intensity of ion-cluster beam unstable. The method has not reached the stage of practical use.

### SUMMARY OF THE INVENTION

The present invention eliminates the drawbacks of the above-mentioned MCI method and its object is to provide an ionization method and apparatus in which the desorption of protein molecules having a molecular weight of more than tens of thousands is possible and it is possible to suppress recombination of positive- and negative-ion molecules and perform high-sensitivity mass analysis.

An ionization method according to the present invention comprises steps of generating charged droplets (liquid drops) of a volatile liquid; introducing the charged droplets generated into an evacuated (vacuum) chamber; and forming an electric field in the evacuated chamber and accelerating the charged droplets by the electric field to cause them to bombard a sample, thereby desorbing and ionizing the sample. The ionized molecules are introduced to a mass analyzer.

An ionization apparatus according to the present invention comprises: an accelerator having an evacuated (vacuum) acceleration chamber, in the interior of which accelerating electrodes and a sample table are disposed, provided outside of an ion introduction port of a mass analyzer and communicating with the interior of the mass analyzer through the ion introduction port; and a charged-droplet generating device, which has a charged-droplet generating chamber that communicates with the evacuated acceleration chamber through a droplet introduction port of the evacuated acceleration chamber, for generating charged droplets of a volatile liquid in the charged-droplet generating chamber; wherein the charged droplets generated by the charged-droplet generating device are introduced from the charged-droplet generating chamber to the evacuated acceleration chamber through the droplet introduction port, the droplets are accelerated by the accelerating electrodes, to which a high voltage has been applied, and bombard a sample on the sample table, and ions of the sample desorbed and ionized thereby are introduced to the mass analyzer through the ion introduction port.

The ionization method according to the present invention is implemented using this ionization apparatus.

An example of the volatile liquid (solvent) is preferably water. Methanol, ethanol, or a mixed solution of water/methanol (to which acetic acid or ammonia, etc., has been added) may also be used as the volatile liquid. The water includes water to which weakly acidic or alkalic solutions are added.

In order to suppress vaporization (evaporation) of solvent molecules from the charged droplets generated, desirably the volatile liquid or charged droplet generated is cooled preferably to a temperature that prevails just prior to solidification of the charged droplets in the generation of the charged droplets (up to introduction into the evacuated chamber or evacuated acceleration chamber). Charged droplets that have been generated are introduced up to the evacuated chamber (or evacuated acceleration chamber) in the cooled state. However there is a case in which the charged droplets are not necessarily cooled.

Preferably, the electrospray method is used to generate the charged droplets. If combined use is made of cooled nitrogen (N₂) gas that has been subjected to temperature control, cooling, generation (atomization) of the charged droplets and feed into the evacuated chamber (evacuated acceleration chamber) can be performed efficiently. Generation of the charged droplets can be performed under atmospheric pressure (inclusive of reduced pressure).

In accordance with the present invention, a volatile liquid is used and not glycerol as in the MCI method. As a result, the problem of decontamination of the ion source does not occur.

In accordance with the present invention (in accordance with the above-mentioned electrospray method in particular), it is possible to generate charged droplets on the micron order.

In the preferred embodiment, since the charged droplets are introduced from the charged-droplet generating chamber to the evacuated chamber (evacuated acceleration chamber) in the cooled state, vaporization (drying) of the charged droplets is kept very low and sampling is performed within the evacuated chamber (evacuated acceleration chamber) while the size of the micron-order droplets is maintained.

The massive cluster ions are accelerated by an electric field within the evacuated chamber (evacuated acceleration chamber), whereby they are imparted with kinetic energy and bombard the sample (e.g., a thin film of a biological sample). Shock waves are produced at the impact boundary and the sample is vaporized and ionized on the order of picoseconds.

Since the sample is bombarded with cluster ions of massive size, electronic and vibrational excitation of the target molecule does not occur at the time of impact and only the kinetic energy of the molecules in the sample thin film is selectively excited. Thus, since the sample is subjected to soft impact by massive cluster ions, even molecules having molecular weights that exceed several tens of thousands will be ionized without sustaining damage.

Further, since the sample is vaporized and ionized in a short period of time of picoseconds, which is shorter than the recombination lifetime of positive and negative ions, recombination is suppressed and the ions generated can be introduced to the mass analyzer more efficiently.

As the biological sample used, one that has been frozen to prevent drying may be employed.

### BRIEF DESCRIPTION OF THE DRAWING

FIG. 1 is a diagram of the structure of an ionization apparatus.

### DESCRIPTION OF THE PREFERRED EMBODIMENTS

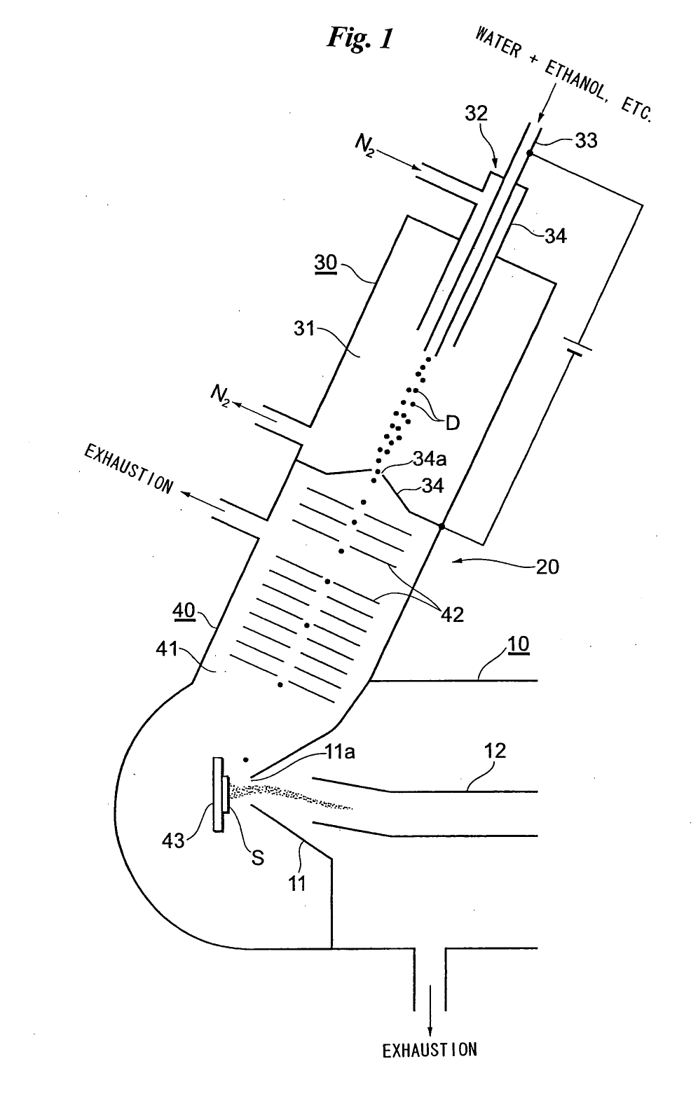

In FIG. 1, a portion of a mass analyzer (mass spectrograph or spectrometer) 10 that includes an ion introduction port is equipped with an ionization apparatus 20.

A skimmer 11 having a hole 11a is attached to the portion of the mass analyzer (e.g., a time-of-flight mass analyzer) 10 having the ion introduction port. Directionally aligned ions are introduced into the mass analyzer by the hole (ion introduction port) 11a. The interior of the mass analyzer 10 is maintained at a high vacuum by an exhaust device (not shown).

The ionization apparatus 20 comprises a charged-droplet generating device 30, which has a charged-droplet generating chamber (an ion-source chamber or cold electrospray chamber) 31, and a accelerator 40 having an evacuated acceleration chamber 41 continuing from the charged-droplet generating chamber 31 in a straight line.

The charged-droplet generating device 30 has a cold electrospray unit 32 which has a metal (electrically conductive) capillary 33 to which a high voltage is applied, and a surrounding tube 34 covering the periphery of the capillary in spaced-apart relation. The ends of the metal capillary 33 and surrounding tube 34 project into the interior of the charged-droplet generating chamber 31. A volatile liquid (solvent) that will become charged droplets is supplied to the metal capillary 33. The space between the metal capillary 33 and surrounding tube 34 is supplied with a coolant, e.g., cold nitrogen (N₂) gas, as a nebulizer gas. The nitrogen gas is generated from liquid nitrogen and is introduced to the surrounding tube 34 upon having its temperature controlled.

Highly charged, very fine droplets (having a diameter on the order of several microns) D are sprayed into the charged-droplet generating chamber 31 from the tip of the metal capillary 33 to which high voltage has been applied. Further, the nitrogen gas is injected into the charged-droplet generating chamber 31 from the tip of the surrounding tube 34 in the periphery of the tip of the metal capillary 33. The nitrogen gas assists in spraying the charged droplets, cools the charged droplets and conveys the charged droplets D toward the evacuated acceleration chamber 41 in the cooled state. The nitrogen gas is exhausted from the charged-droplet generating chamber 31 to the outside via an exhaust port.

The charged droplets constitute a volatile liquid. When the charged droplets are vaporized (dried), droplet size diminishes. In order to suppress the vaporization of the charged droplets, it is the nitrogen gas that cools the charged droplets in the generation thereof and until the charged droplets reach the evacuated acceleration chamber 41. Preferably, the cooling temperature is just short of that at which the charged droplets will solidify.

An example of volatile liquids that will become the charged droplets that can be mentioned is water (to which weakly acidic or alkalic solutions such as acetic acid or ammonia may be added). Methanol or acetonitrile may be added into water. Methanol itself may be used as the volatile liquids. Water/methanol mixture (to which acetic acid or ammonia, etc., has been added) may be also used. A cooling temperature for preventing vaporization of the charged droplets is a temperature in the vicinity of dry ice—acetone in the case of the water/ethanol mixture (to which acetic acid or ammonia, etc., has been added).

In this embodiment, the charged droplets are cooled by the temperature-controlled nitrogen gas. However, it may be so arranged that the entirety of the charged-droplet generating device 30 or the charged-droplet generating chamber 31 is cooled to a prescribed temperature by the cooling apparatus. An ultrasonic vibrating apparatus is another example of a charged-droplet generating device. Though the interior of the charged-droplet generating chamber 31 is at atmospheric temperature, the chamber may be held in a state of reduced pressure. The charged-droplet generating device 30 or the charged-droplet generating chamber 31 may not be cooled in some cases. These device 30 or chamber 31 may be warmed in other cases.

An orifice 34 is provided at the boundary of the charged-droplet generating chamber 31 and evacuated acceleration chamber 41, and a miniscule hole 34a is formed in the orifice 34. The miniscule hole 34a is a charged-droplet introduction port 34a. The charged-droplet generating chamber 31 and evacuated acceleration chamber 41 are communicated with each other through the charged-droplet introduction port 34a.

The charged droplets D sprayed from the tip of the metal capillary 33 move in the direction of the evacuated acceleration chamber 41 together with the cooled nitrogen gas within the charged-droplet generating chamber 31 and are introduced into the evacuated acceleration chamber 41 through the miniscule hole 34a of the orifice 34.

Accelerating electrodes 42 and a sample table 43 are provided inside the evacuated acceleration chamber 41. A positive or negative (whichever is opposite the polarity of the charged droplets) high voltage (e.g., 10 KV) is applied to the accelerating electrodes 42. The charged droplets D that have been introduced to the interior of the evacuated acceleration chamber 41 are accelerated and converged (focused) by the accelerating electrodes 42 and bombard a sample S, which has been provided on the sample table 43, at an angle, and molecules that have been ionized from the sample are desorbed. The interior of the mass analyzer 10 and the evacuated acceleration chamber 41 are communicated via the ion introduction port 11a, which is provided in the skimmer 11. Ion molecules (or atoms) that have been generated by charged-droplet bombardment and that have flown perpendicularly from the surface of the sample S (sample table 43) are introduced into the mass analyzer 10 through the ion introduction port 11a.

The charged droplets thus generated by the charged-droplet generating device 30 have a size on the order of microns. These are referred to as massive cluster ions. The massive cluster ions are introduced from the charged-droplet generating chamber 31 to the evacuated acceleration chamber 41 while maintaining their micron-order droplet size and are accelerated by the electric field of the accelerating electrodes 42. For example, the massive cluster ions are imparted with a kinetic energy on the order of 10 KeV.

The biological sample thin film S, which has been frozen to prevent drying, for example, is held by the sample table 43. The accelerated massive cluster ions bombard the biological sample thin film S (e.g., a biological sample that has been applied to porous silicon). As a result, the thin-film sample is vaporized in a short time of picoseconds. Though positive and negative ions exist in the sample in equal quantities, the ions are generated in a length of time that is shorter than the recombination lifetime of these ions. Accordingly, recombination of (a neutralization reaction between) the generated ions is prevented and many ions are supplied from the evacuated acceleration chamber 41 into the mass analyzer 10 through the ion introduction port 11a. This makes highly sensitive mass analysis possible.

Further, since the sample is bombarded with cluster ions of massive size, electronic and vibrational excitation of the target molecule does not occur at the time of impact and only the kinetic energy is selectively excited. As a result, even molecules such as proteins having molecular weights that exceed several tens of thousands will be ionized without sustaining damage. In other words, mass analysis (e.g., orthogonal time-of-flight mass analysis) of biological molecules inclusive of protein becomes possible.

What is claimed is:

1. An ionization method using cluster-ion impact, comprising steps of:
generating charged droplets of water or water/methanol mixture in a state in which the droplets are cooled so as to suppress vaporization thereof;
introducing the charged droplets generated into an evacuated chamber; and
forming an electric field in the evacuated chamber and accelerating the charged droplets by the electric field to cause them to bombard a biological sample, thereby desorbing and ionizing the biological sample.

2. An ionization apparatus using cluster-ion impact, comprising:
an accelerator having an evacuated acceleration chamber, in the interior of which accelerating electrodes and a sample table are disposed, provided outside of an ion introduction port of a mass analyzer and communicating with the interior of the mass analyzer through the ion introduction port; and
a charged-droplet generating device, which has a charged-droplet generating chamber that communicates with said evacuated acceleration chamber through a droplet introduction port of said evacuated acceleration chamber, for generating charged droplets of water or water/methanol mixture in the charged-droplet generating chamber in a state in which the droplets are cooled so as to suppress vaporization thereof;
wherein the charged droplets generated by said charged-droplet generating device are introduced from said charged-droplet generating chamber to said evacuated acceleration chamber through said droplet introduction port, the droplets are accelerated by said accelerating electrodes, to which a high voltage has been applied, and bombard a biological sample on the sample table, and ions of the biological sample desorbed and ionized thereby are introduced to the mass analyzer through said ion introduction port.

3. An ionization method using cluster-ion impact, comprising steps of:
generating charged droplets of a volatile liquid including water under atmospheric pressure;
introducing the charged droplets generated into an evacuated chamber; and
forming an electric field in the evacuated chamber and accelerating the charged droplets by the electric field to cause them to bombard a sample, thereby desorbing and ionizing the sample.

4. An ionization method using cluster-ion impact, comprising steps of:
generating charged droplets of a volatile liquid;
introducing the charged droplets generated into an evacuated chamber; and
forming an electric field in the evacuated chamber and accelerating the charged droplets by the electric field to cause them to bombard a sample, thereby desorbing and ionizing the sample.

5. An ionization apparatus using cluster-ion impact, comprising:
an accelerator having an evacuated acceleration chamber, in the interior of which accelerating electrodes and a sample table are disposed, provided outside of an ion introduction port of a mass analyzer and communicating with the interior of the mass analyzer through the ion introduction port; and
a charged-droplet generating device, which has a charged-droplet generating chamber that communicates with said evacuated acceleration chamber through a droplet introduction port of said evacuated acceleration chamber, for generating charged droplets of a volatile liquid in the charged-droplet generating chamber;
wherein the charged droplets generated by said charged-droplet generating device are introduced from said charged-droplet generating chamber to said evacuated acceleration chamber through said droplet introduction port, the droplets are accelerated by said accelerating electrodes, to which a high voltage has been applied, and bombard a sample on the sample table, and ions of the sample desorbed and ionized thereby are introduced to the mass analyzer through said ion introduction port.
